(19) United States
(12) Patent Application Publication
(10) Pub. No.: US 2021/0197631 A1
(43) Pub. Date: Jul. 1, 2021

(54) TIRE CASING FITTED WITH A MEASUREMENT SYSTEM AND METHOD OF COMMUNICATION FOR SUCH AN ASSEMBLY

(71) Applicant: COMPAGNIE GENERALE DES ETABLISSEMENTS MICHELIN, Clermont-Ferrand (FR)

(72) Inventors: LIONEL FAGOT-REVURAT, Clermont-Ferrand (FR); JULIEN DESTRAVES, Clermont-Ferrand (FR)

(21) Appl. No.: 17/058,898

(22) PCT Filed: May 29, 2019
(86) PCT No.: PCT/FR2019/051276

§ 371 Date: Nov. 25, 2020

(30) Foreign Application Priority Data
May 29, 2018 (FR) 1854569

(51) Int. Cl. B60C 23/04

(52) U.S. Cl. CPC B60C 23/0493; B60C 23/0447; B60C 23/0444

(57) ABSTRACT

An arrangement comprises a tire casing, an electronic device for measuring a mounted assembly and an interface for bonding the casing and the electronic device, made of elastomeric material and covering the electronic device. The measuring electronic device comprises: a UHF radiofrequency antenna; and a circuit board with an electronic chip coupled to the UHF radiofrequency antenna and a sensor for measuring a parameter of the mounted assembly. The tire casing comprises: a crown, two sidewalls and two beads of revolution about a reference axis and first and second surfaces located internally and externally to the tire casing; and a median plane perpendicular to the reference axis. The interface is fastened in line with the crown to the second surface of the tire casing, and the feed point is located axially in the central region of the crown.

The present invention relates to an aircraft tyre casing equipped with an electronic device for monitoring a parameter of a mounted assembly, enabling, on-demand, interrogation remotely, i.e. without physical operations on the mounted assembly, whatever the position of the operator with respect to the mounted assembly.

In recent years, for regulatory reasons, wheel modules built around a technology known as TPMS (acronym of “Tyre Pressure Monitoring System”) have been developed that allow communication to be established with the mounted assembly, with a view to preventing the risk of accident in the event, for example, of the mounted assembly losing inflation pressure. These are active electronic devices comprising, on the one hand, sensors that measure parameters of the mounted assembly, such as, for example, the inflation pressure, or the temperature of the pressurized fluid contained between the tyre casing and the rim, and, on the other hand, radiofrequency communicating means with a dedicated power source for communicating with the vehicle or a control unit. These wheel modules also generally comprise an electronic chip and a memory space in order to manage, post-process or store quantities of the mounted assembly component.

The functionalities of these wheel modules, which are integrated into one of the components of the mounted assembly, such as for example the rim or the tyre casing, are regularly improved. The latest developments, which are generally based on TMS technology (TMS being the acronym of “Tyre Mounted Sensor”), propose to relocate all or part of this wheel module to the crown block of the tyre casing.

However, in the field of aviation, the high thermomechanical stresses experienced by mounted assemblies during take-off and landing, as well as regulatory constraints related to this activity, make the use of battery-powered electronic systems complex, because of movable elements present in the batteries. On the one hand, these mechanical stresses, such as those generated by the shock of impact on entry into or exit from the contact area at high speed, cause premature and uncontrolled deterioration of these movable components. On the other hand, it is necessary to ensure that the incorporation of these electronic systems is not detrimental to the endurance of the mounted assembly and more particularly to the tyre casing. Therefore, it is necessary to optimize the integration of this electronic system into the mounted assembly.

In addition, the violent thermal stresses associated with braking make the temperature within the mounted assembly non-uniform. Thus, the measurement of the temperature of the fluid-filled cavity of the mounted assembly is strongly influenced by the location of the sensor with respect to these heat sources. For example, measurement of temperature using a TPMS mounted on the rim valve is greatly influenced by heating of the wheel during braking.

The inflation pressure of mounted assemblies for aviation applications is very high. Thus, because of the risk that the tyre casing will burst if handled improperly, manual maintenance operations on the mounted assembly must be carried out with care.

Lastly, in order to make use of such a system for measuring the parameters of the mounted assembly easier, it is necessary for communication to be possible from both sides of the mounted assembly, in the direction of the axis of rotation of the tyre casing, whatever the position in which the mounted assembly is stopped.

The technical problem addressed is that of design of a tyre casing equipped with an electronic radiocommunication system that is compatible with the thermomechanical stresses experienced by the mounted assembly and the regulatory constraints of aviation, while enabling easy communication at any time and at any distance from the electronic system.

The invention relates to an arrangement comprising: a tyre casing that defines, in association with a wheel, a mounted assembly; an electronic device for measuring a parameter of the mounted assembly; and a bonding interface made of elastomeric material that serves as an interface between the tyre casing and the electronic device and that partially covers the electronic device. The measuring electronic device comprises:
a UHF radiofrequency antenna defining a polar axis; and
a circuit board comprising:
   an electronic chip electrically coupled to the UHF radiofrequency antenna by a galvanic transmission line; and
   at least one sensor for measuring a parameter of the mounted assembly;
      The tyre casing comprises:
a crown, two sidewalls and two beads of revolution about a reference axis defining a first surface located externally and a second surface located internally to the tyre casing with respect to the reference axis; and
a median plane perpendicular to the reference axis and equidistant from the two beads.
   The arrangement is characterized in that the bonding interface is fastened in line with the crown to the second surface of the tyre casing and in that a feed point, defined as the intersection between the polar axis and the transmission line, is located axially in the central region of the crown of the tyre casing.

The arrangement allows communication via a UHF (acronym of ultra high frequency) radiofrequency transceiver located at a distance from the mounted assembly. The UHF band is the best possible compromise between a small UHF-radiofrequency-antenna size and a suitable radiofrequency read distance. In addition, the small size of the radiofrequency antenna (it is of the order of a few centimetres in length) makes it easier to integrate into the mounted assembly and in particular into the tyre casing without notable detriment to the endurance of the various structures. In addition, the insertion of the radiofrequency antenna into a bonding interface made of an elastomer blend enables a change in the propagation speed of the radiofrequency waves with respect to free space, allowing the useful length of the radiofrequency antenna of the measuring electronic device to be decreased. This radiofrequency device comprises a radiofrequency transmitter intended to transmit to the measuring electronic device and a radiofrequency receiver intended to receive its response. These two functions may be performed by the same communicating instrument. This UHF radiofrequency device transmits radiofrequency waves in the UHF frequency band between 300 MHz and 3 GHz, and in particular at frequencies of about 430 MHz and between 860 and 960 MHz, which are received by the UHF radiofrequency antenna of the measuring electronic device.

The captured radiofrequency energy is then transmitted as electrical energy to the electronic chip, in order to activate the circuit board. The use of electrical coupling between the radiofrequency antenna and the electronic chip optimizes the efficiency of the power transfer between these components, contrary to electromagnetic coupling solutions such as inductive solutions, the efficiency of which is lower.

The measuring electronic device does not include a battery or an energy accumulator and in this respect it meets the constraints of the technical problem that the invention seeks to address.

Lastly, the communication transmitted by the electronic chip is transmitted passively, without a power source. The transmitted signal is reflected and modulated, based on the received signal, via an impedance variation of the electronic chip.

Positioning the bonding interface in line with the crown allows the integrity of the tyre casing to be ensured. Specifically, the crown is a rigid and massive region of the tyre casing dimensioned to withstand the severe thermomechanical stresses generated by the contact between the tyre casing and the runway, hence the integration of a bonding interface made of elastomeric material does not affect the crown mechanically or thermally.

By “central region of the crown of the tyre casing”, what is meant here is a region corresponding to 25% of the width of the tyre casing which is centred on the median plane of the tyre casing. The width of the tyre casing is obtained using the dimensional and standard characteristics of the tyre casing inscribed on the external surface of its sidewalls.

Positioning the feed point of the UHF radiofrequency antenna within the central region of the crown ensures communication with the radiofrequency device is possible from both sides of the tyre casing, one side not being favoured over the other. This communication through both sidewalls of the tyre casing is achievable whatever the azimuthal or radial position of the electronic device with respect to the tyre casing. In particular, even if the azimuthal position of the electronic device is contained in the angular segment of the tyre casing making contact with the ground, which segment is commonly called the “contact area”, it will be possible to communicate with the radiofrequency device through both sides of the tyre casing.

According to one particular embodiment, the circuit board in addition comprises a microcontroller, a capacitive element and a power manager. All the components of the circuit board are low-consumption components.

The electronic chip, the microcontroller and the sensor for measuring a parameter of the mounted assembly are here components the power consumption of which is low, allowing the power consumption of the circuit board to be optimized. The expression “low-consumption” is here understood to mean that they have a low activation energy. Furthermore, their standby mode minimizes leakage currents and their operating time is short. In addition, the electronic chip optimizes the transfer of energy to the circuit board via a power manager. This controls the charge and discharge of a capacitive element that stores a certain amount of energy without having the structural drawbacks of a battery. However, the amount of energy stored is generally lower than in a battery. The power manager releases energy to the circuit board when a certain threshold level of storage in the capacitive element is reached. This release of energy wakes, in the context of this embodiment, the turned-off components of the circuit board and then launches the measurement sequence. Furthermore, the measuring sensor optimizes its power consumption by way of the microcontroller.

Advantageously, an analogue/digital converter is employed between the microcontroller and the measuring sensor to convert digital information into analogue information intended for or coming from the analogue measuring sensor. The collected digital information is then transmitted to the memory space of the electronic chip, before being transmitted by impedance modulation to the UHF radiofrequency antenna. The latter converts the electrical signal into a radiofrequency signal that is transmitted to the receiving radiofrequency device.

According to a very particular embodiment, the measuring electronic device comprises a ground plane connected to the circuit board.

This configuration allows the same voltage reference to be employed for all the components of the circuit board. This allows parasitic disturbance of the circuit board in its entirety to be minimized, thus limiting the background noise in the measurements of the electronic device and allowing the circuit board to operate, for example, at a lower energy level.

Advantageously, the feed point of the UHF radiofrequency antenna is located in the median plane of the tyre casing.

In this specific case, the equidistance of the radiofrequency antenna with respect to the beads of the tyre casing, and therefore with respect to the two sidewalls, ensures an equivalent communication from both sides of the tyre casing, if the potentially disruptive external environment is the same on both sides.

According to one preferred embodiment, the tyre casing comprises a visual indicator located on the first surface of the tyre casing in line with one of the sidewalls. The bonding interface is located at an azimuth separated from the azimuth of the visual indicator by less than 15 degrees, preferably less than 5 degrees and very preferably the two azimuths are aligned.

The presence of this visual indicator on the portion visible from the exterior of the tyre casing allows the operator to locate the best region of communication with the electronic device. Although alignment of the two azimuths is the preferred configuration, the tyre casing remains an industrial object subject to its own constraints, in particular with respect to the standards that apply to the marking of the exterior sidewalls, and hence an off-centredness of the two azimuths is tolerated provided it does not modify the capacity of a radiofrequency device located outside the mounted assembly and the electronic device of the arrangement to communicate. In addition, this visual indicator may contain information on the direction of the polar axis of the UHF radiofrequency antenna. This allows the radiofrequency coupling between the transceiver located outside the mounted assembly and the radiofrequency antenna of the electronic device to be optimized via alignment of the transmitted electric field with the equipotential lines of the receiving device.

According to one particular embodiment, the UHF radiofrequency antenna is a single-band half-wave dipole antenna, the total length L of which is comprised between the following limits:

0.9*C/(2*f)<L<1.1*C/(2*f),

in which, C is the speed of the radiofrequency waves in the medium in which the UHF radiofrequency antenna (20) is embedded and f is the communication frequency of the UHF radiofrequency antenna (20).

Among UHF radiofrequency antennas, the half-wave dipole antenna is an antenna of elementary and inexpensive design composed mainly of at least two coaxial strands that are aligned with the axis of the antenna, the strands being joined together at the feed point of the antenna at one of their ends and extending in opposite directions to each other. In addition, integration of this antenna of elementary design into the tyre casing is easier than in the case of directional or multi-band antennas. The total length L of the antenna corresponds to the half-wavelength of the radiofrequency antenna. When the antenna is single-band, the operating frequency of use of the antenna is constrained to a narrow bandwidth around a central frequency. This allows the energy to be focused in a narrow spectrum of frequencies, maximizing the energy transfer between the UHF radiofrequency device and the radiofrequency antenna, both in transmission and in reception. If the power transmitted to or from the radiofrequency antenna is limited, this type of design maximizes transfer of radiated energy. Lastly, the half-wave dipole antenna allows energy to be transmitted to a large space around the antenna, both in transmission and in reception—it is a so-called omnidirectional antenna. Thus, due to the random angular position of the radiofrequency antenna with respect to the terrestrial reference frame and due to the random position of the UHF radiofrequency device with respect to the mounted assembly, this type of antenna is well suited to use in a mounted assembly.

It will be noted that radiofrequency waves travel at speeds that depend on the, in particular dielectric, nature of the medium in which the communication antenna is located. Thus, since the radiofrequency antenna of the measuring system is embedded in an interface made of an elastomer blend, an average dielectric permittivity value of 5 needs to be taken into account when determining the speed C of the radiofrequency waves.

According to one very particular embodiment, the half-wave dipole antenna is formed by at least two strands, the length of the path L0 travelled along each strand being comprised between the following limits:

0.5*C/(4*f)<L0<2.0*C/(4*f),

in which, C is the speed of the radiofrequency waves in the medium in which the strand is embedded and f is the communication frequency of the UHF radiofrequency antenna.

Although a half-wave dipole antenna operates at a central frequency dependent on the half-wavelength, integration of a half-wave dipole antenna into a tyre casing causes changes to the radiofrequency operation of the antenna. In fact, the wavelength of the antenna is dependent not only on the central frequency but also on the speed coefficient of the waves in the medium in which the antenna is embedded. Now, the elastomer blends, these including the bonding interface but also the tyre casing, have a notable influence on this speed coefficient, in particular because they modify the relative permittivity of the medium in which the radiofrequency antenna is located. Of course, depending on the chemical composition of the elastomer blends or of the fabrics made from these elastomer blends, and in particular on the carbon-black content, the relative dielectric permittivity of the medium with respect to free space changes. Because of the non-uniformity of the blends employed in the bonding interface and within the tyre casing, of their geometry and of the diversity of possible locations of the measuring system in the tyre casing, the range of values that the length of the path travelled in each strand of the antenna may have is wide, to accommodate all situations. In this case, an average relative elastomer-blend permittivity is taken as reference, a value of about 5 thus being defined.

Advantageously, each strand of the half-wave dipole antenna is a linear strand, a meander, a curved strand or a helical strand.

These are various designs that each strand of the half-wave dipole antenna may have. The most conventional type of strand is the linear strand, which has the smallest spatial bulk because of its one-dimensional character. It allows the energy transfer between the radiofrequency energy exchanged with the radiofrequency device and the electrical energy transmitted to the radiofrequency antenna to be optimized. Specifically, efficiency is optimal if the entirety of the length of the strand is perfectly aligned with the electric field generated by the radiofrequency waves. However, such a strand exhibits fragility under mechanical stresses applied transverse to the direction of the strand. Lastly, this type of strand is bulky in its main dimension compared to the dimensions of the tyre casing, only moderately facilitating its integration into this object, above all if the latter is small.

The meander and curved solutions make the strand compact in terms of length to the detriment of an elongation in the second direction of the plane of the antenna. Specifically, these are two-dimensional strands the dimension of which in the direction normal to the plane of the strand is small with respect to the other dimensions of the plane of the strand. These shapes naturally facilitate the integration of the strand into the tyre casing. Thus, the mechanical endurance of the tyre casing and of the radiofrequency antenna are improved. However, this improvement is to the detriment of energy efficiency, due to the non-alignment of the entirety of the strand with the direction of the electric field generated by the radiofrequency waves.

Lastly, the helical strand is a three-dimensional structural element well suited to absorbing the thermomechanical deformations experienced by the tyre casing, whatever the direction of the stress, thus ensuring the radiofrequency antenna has a good mechanical endurance and making it easier to position the antenna in the tyre casing. In addition, the compactness of the strand, which compactness is enabled by the third dimension, makes it easier to integrate the radiofrequency antenna into the tyre casing, in particular in the case of small tyre casings. However, this compactness is to the detriment of the efficiency of the energy transfer. Lastly, this type of antenna is complex as regards its production and its integration into a circuit board, which by nature is two-dimensional.

In summary, depending on the dimensions of the tyre casing (making integration of the strand easier or more difficult), on the power consumption of the measuring device and on where it is chosen to put the measuring device in the tyre casing, it is recommendable to prefer one design of strand over another. However, it is quite possible for a number of different shapes to be combined in the same strand and for various strands of the half-wave dipole antenna to have various strand shapes.

According to one specific embodiment, the dipole antenna comprises a folded strand forming a loop the half-perimeter D of the strand of which, as defined by the direction of the UHF radiofrequency antenna, defining the travelled path L0, is comprised between the following limits:

0.5*C/(4*f)<D<2.0*C/(4*f)

where C is the speed of the radiofrequency waves in the medium in which the strand is embedded and f is the communication frequency of the UHF radiofrequency antenna.

This is another embodiment of a strand of the half-wave dipole antenna. It is a two-dimensional structural element since the dimension of the loop in the direction normal to the loop is small compared to the other main dimensions of the loop. The half-perimeter is defined using the geometric points of the loop that are located at the intersection of the direction of the UHF radiofrequency antenna with the loop. Because of the non-uniformity of the elastomer blends of the bonding interface and of a tyre casing, of the variability in the position of the measuring device with respect to the bonding interface and of the various positions in which the measuring system may be placed in the tyre casing, it is recommendable to precisely adjust the length D on a case-by-case basis, to optimize the exchange of energy between the power radiated by the radiofrequency device and the radiofrequency antenna. However, a defined value in the proposed interface makes it possible to ensure a sufficient amount of energy for the measuring system to operate.

According to one very specific embodiment, the loop of the strand has a shape contained in the group comprising a circle, an ellipse, an oval, a rectangle, a rhombus, a square and a polygon.

Whatever the shape of the loop, it allows a closed loop defining a perimeter to be produced. Thus, the shape of the loop may be tailored to the geometric constraints of the electronic device. In particular, the proximity of the radiating antenna to the circuit board may influence the space available to define the loop of the strand of the radiating antenna. To make the electronic device as compact as possible, with a view to optimizing the mechanical endurance of the electronic device and of the tyre casing that must accommodate it, the designer will choose one particular strand architecture, while taking into account the cost and constraints of manufacture of such a strand.

According to another very particular embodiment, the loop of half-perimeter D is integrated into the ground plane of the electric circuit.

The size of the ground plane allows the half-perimeter loop D to be produced in the ground plane as a strand of the dipole antenna. This strand structure improves the mechanical strength of the antenna strand and, moreover, minimizes the cost of manufacture of the dipole antenna.

Advantageously, an oriented path L1 of the strand representing at least 50% of the travelled path L0 of at least one strand is oriented in the direction of the UHF radiofrequency antenna.

If the length of the travelled path L0 allows the resonant frequency of the radiating antenna to be centred on the central frequency of the radiofrequency device in communication with it, it is also possible to improve the energy efficiency of the transfer between these two structures by aligning the axis of the radiating antenna with the electric field of the radiofrequency device. Of course, efficiency is maximum if the electric field of the radiofrequency device is constant and the radiating antenna is perfectly aligned. However if 50% of the length of the strand is aligned, the efficiency is sufficient for the electronic device to work. There is a compromise between the efficiency of the energy transfer from the radiofrequency device to the electronic device and the mechanical endurance of the radiating antenna once inserted into a tyre casing.

Very advantageously, an optimal oriented path L2 representing at least 70% and preferably 80% of the oriented path L1 of the strand is continuous. In addition, the optimal oriented path L2 is located in the portion of the strand comprising the feed point of the radiofrequency antenna.

These distinctive features have similar and additional effects on the energy transfer between the radiating antenna and the radiofrequency device. Specifically, these features increase the interaction between the electric field of the radiofrequency device and the magnitude of the electric current flowing through the radiating antenna, this current communicating directly with the electric circuit of the electronic device.

According to one specific embodiment, one portion of the circuit board, one portion of the ground plane and one portion of the UHF radiofrequency antenna are embedded in a mass of parylene.

Certain components of the circuit board, such as the measuring sensors, may need to make contact with the fluid bounded externally by the measuring system. However, this fluid is not perfect by nature. The fluid may have a variable moisture content, but may also contain dirt or impurities that may influence the response of the measuring sensor. Likewise, the radiating antenna and the ground plane of the measuring system may make direct contact with this fluid and undergo the same types of physico-chemical attacks. For these reasons, the hermetic protection provided by the parylene is advantageous.

The elements of the measuring system are fragile by their very structure and the connections between its elements are weak points. The measuring system is intended to be inserted into an aircraft tyre casing, to which high thermomechanical stresses will be applied. The parylene also protects its components mechanically, although this is not its primary role.

According to one preferred embodiment, the UHF radiofrequency antenna is connected to an impedance-matching circuit located between the UHF radiofrequency antenna and the electronic chip.

The impedance-matching circuit improves the transfer of power between the UHF radiofrequency antenna and the electronic chip, by minimizing the loss of power between these two components. This allows the electrical power transmitted to the electronic chip and therefore to the circuit board to really be increased. This matching is particularly necessary when the radiating antenna is unbalanced, such as is the case when the two strands of the half-wave dipole are of different design. It balances the radiating antenna and matches the impedance of the radiating antenna to that of the electronic chip. This matching is carried out using circuits that are ideally purely capacitive, resistive or inductive, but that may, depending on the matching requirements, be a combination of such circuits.

According to one particular embodiment, the bonding interface is equipped with a through-orifice that places the fluid located externally to the measuring system in communication with at least one active region of the at least one sensor for measuring a parameter of the mounted assembly.

Specifically, if the sensor for measuring the mounted assembly measures physico-chemical properties of the pressurized fluid cavity formed by the mounted assembly, such as the inflation pressure, these sensors must be in connection with this fluid cavity. Since the bonding interface is inserted between the tyre casing and the electronic device, the orifice allows the active portion of the measuring sensor to be brought into communication with the fluid cavity.

According to another particular embodiment, the sensor for measuring a parameter of the mounted assembly is a pressure sensor, a temperature sensor, a sensor of vertical position, a sensor of angular position or an accelerometer.

Among sensors for measuring parameters of the mounted assembly, the most commonly employed are pressure and temperature sensors since they directly measure physical quantities directly related to the use and correct operation of the mounted assembly or tyre casing. The temperature sensors measure either the temperature of the fluid in the internal cavity of the mounted assembly or the temperature of specific regions of the tyre casing. However, other measuring sensors such as accelerometers and/or position sensors may also be used to assist with a diagnosis as to whether the mounted assembly or tyre casing is being used correctly or as to the state of the mounted assembly at the point in time when a measurement is taken by another sensor.

According to one preferred embodiment, the polar axis of the UHF radiofrequency antenna is parallel to the circumferential direction of the tyre casing.

In this embodiment, the polar axis is aligned with the circumferential direction of the tyre casing. Thus, the radiofrequency communication with the external transceiver is not affected by the radial position of a transceiver located in line with a sidewall. Specifically, in the direction perpendicular to the polar axis the field radiated by the radiofrequency antenna contains no blind spot. In addition, it is possible to orient the antenna of the external transceiver so as to align its polar axis with the polar axis of the radiofrequency antenna of the electronic device. This embodiment, which is advantageous as regards the transfer of energy between the electronic device and the transceiver, is disadvantageous as regards the mechanical integrity of the electronic device. Specifically, the alignment of the polar axis of the radiofrequency antenna with the circumferential direction of the tyre casing leads said radiofrequency antenna to experience flexural stresses when it passes through the contact area. In addition, if the ground plane of the electronic device is an element of the antenna, the risk of deterioration thereof is accentuated due to the geometry and the material of this component. The best compromise between mechanics and energy is obtained when the electronic device is positioned in a plane parallel to the median plane of the tyre casing. In conclusion, this solution works for arrangements comprising any size of tyre casing. In particular, this type of integration is well suited to casings of large diameter (in such casings the electronic device is stressed less in the regions of entry into and exit from the contact area).

According to another preferred embodiment, the polar axis of the UHF radiofrequency antenna is parallel to the reference axis of the tyre casing.

In this configuration, the radiofrequency antenna is not subjected to flexural stresses, leading to an improvement in the physical integrity of the electronic device and of the radiofrequency antenna in particular. However, the direction of the polar axis leads to a communication blind spot on the side of casing located in the upper portion of the sidewall. Thus, communication with the transceiver located outside the mounted assembly is impaired. In conclusion, this feature will preferably be implemented in tyre casings of large diameter, in which the mechanical stresses on entry into and exit from the contact area are greater. In addition, the dimension of the diameter of the casing is often correlated to the width of the tyre casing. Thus, these tyre casings have a smaller radiofrequency-communication blind spot than casings of small size.

The invention also relates to a method for achieving communication between a mounted assembly comprising such a unit and an external radiofrequency device comprising a radiofrequency antenna having a polar axis, comprising the following steps:
positioning the external radiofrequency device radially at a distance R, with respect to the reference axis of the tyre casing, comprised between one third and all of the height of the tyre casing;
bringing axially, in line with one of the sidewalls of the tyre casing, the polar axis of the radiofrequency antenna of the external radiofrequency device to a distance D0, with respect to the first surface of the tyre casing, defining a first read position; and
transmitting a radiofrequency transmission with the external radiofrequency device for a duration T0 while angularly scanning a first angular sector β of α degrees.

The protocol of communication with the arrangement is firstly defined by the position of the external radiofrequency device with respect to the tyre casing. The device is placed externally to and in line with the sidewall of the tyre opposite the upper portion of the sidewall, away from the wheel. This is done, when the wheel is made of metal, to move the radiofrequency device away from a region of magnetic disturbance caused thereby. Furthermore, in addition, the electronic device of the arrangement is located in line with the crown and inside the internal cavity of the mounted assembly, hence more energy is transmitted toward the electronic device if the external radiofrequency device is located opposite the upper portion of the sidewall. The azimuthal position of the radiofrequency device with respect to the tyre casing is irrelevant.

Next, the communication protocol is characterized by the radiofrequency transmission sequence. The latter comprises a number of essential parameters. Firstly, a transmission duration T0, during which the external radiofrequency device continuously transmits radiofrequency waves to the electronic device. Secondly, an angular scan, to cover an angular sector β of α degrees representing one portion of the tyre casing, this scan being performed by the external radiofrequency device, the scan being animated with any suitable motion. The first parameter makes it possible to ensure that the energy required by the electronic device to perform the measurement and to transmit it back is transferred. The second parameter makes it possible to ensure that, in the absence of any indication as to the location of the electronic device, a large spatial region of the tyre casing is covered.

Advantageously, in the case where no response is received from the electronic device by the external radiofrequency device, one or more of the following additional steps are carried out:
the external radiofrequency device is moved angularly by α degrees with respect to the first read position;
the distance D0 between the polar axis of the external radiofrequency device and the first surface of the tyre casing is decreased by a factor ρ;
the scanning angle α is decreased by a factor μ;
the duration T0 of radiofrequency transmission is multiplied by a factor ρ.

The absence of response from the electronic device may firstly be due to a problem with the spatial coverage of the transmitted radiofrequency signals. Specifically, the maximum energy transmitted in the transmitted signals is limited by regulatory constraints. Thus, effective communication is limited to a segment of the tyre casing representing a given angular sector that is dependent on the distance D0 between the radiofrequency device and the tyre casing and on the amount of energy required by the electronic device to perform its tasks. In the absence of indication as to the azimuthal location of the electronic device in the arrangement, the angular coverage achieved by the operator may be insufficient. To overcome these difficulties, it is proposed either to decrease the distance D0 from the external radiofrequency device, or to change the positional azimuth of the external radiofrequency device.

Next, it is also possible for the exposure time to the radiofrequency signals to be too short to allow enough energy to be transmitted to the electronic device for it to, on the one hand, carry out the requested measurement and, on the other hand, transmit the result of said measurement. This problem with exposure time is potentially the result of a poor match between the angular coverage of the transmitted radiofrequency signals and the angular coverage of the radiofrequency antenna of the electronic device. It may also be due to the transmission duration T0 being insufficient to carry out the measurement protocol of the electronic device or to sufficiently recharge the capacitive element of the electronic device. Thus, decreasing the scanning angle α or increasing the transmission duration T0 are two levers that may be used to overcome these drawbacks.

Of course, the problem of no response from the electronic device may also be the result of a combination of these problems, and it is then necessary to combine the technical solutions to obtain the desired response.

According to one preferred embodiment, the distance D0 between the polar axis of the external radiofrequency device and the first surface of the tyre casing is comprised between 0 and 1 metre. However, it is preferable to use an upper limit of 70 centimetres and very preferably 50 centimetres, to limit the risk of no response from the electronic device in interrogation mode. Of course, if the distance D0 is zero, the distance between the components is decreased, this necessarily improving the radiofrequency energy transfer between the two components, all other interrogation conditions being equal.

According to another preferred embodiment, if the tyre casing of the arrangement has a visual indicator providing the operator with information on the azimuthal location of the electronic device, it is recommended to position the external radiofrequency device in line with this visual indicator.

Thus, the presence of this visual indicator gives an indication as to the azimuthal location of the electronic device within the tyre casing of the arrangement. Thus, the scan of α degrees performed in interrogation mode is guaranteed not to penalize the energy transfer between the external radiofrequency device and the electronic device. Thus, the operator no longer has to change the read position of the external radiofrequency device. A lack of response from the electronic device may then only be due, on the one hand, to the transmission duration being too short for the electronic device to harvest enough radiofrequency energy or, on the other hand, to the transfer coefficient being too low as a result of the distance between the two components.

Very advantageously, the angular sector β scanned during the radiofrequency transmission is 30 degrees, preferably 20 degrees and very preferably 5 degrees.

In a configuration in which the distance D0 between the external radiofrequency device and the electronic device is zero, and in the absence of a visual indicator on the tyre casing, a wide scan may be necessary to enter into communication with the electronic device. However, if the scan is too wide, the risk of no response from the electronic device increases. Thus, an intermediate angular sector is preferred, in particular when a visual indicator is present. Of course, if the visual indicator is located at the same azimuth as the electronic device, a narrow scan is then an ideal way to transfer a maximum amount of electrical energy to the electronic device, in a given interrogation duration.

Very advantageously, the scanning duration T0 of the radiofrequency transmission is comprised between 0.02 seconds and 2 seconds, preferably between 0.5 and 1.5 seconds and very preferably is 1 second.

As the duration of the transmission mode is a parameter that is essential to the transfer of energy between the external radiofrequency device and the electronic device, it is dependent on the amount of energy required and on the relative position of the radiofrequency antenna of the electronic device with respect to the external device. The mentioned range is sufficient to obtain a response from the electronic device. The first range incorporates unavoidable delays associated with the operations that must be performed by the electronic device to take the measurement and transfer it by radiofrequency to the external device.

However, due to the uncertainty in the position of the electronic device within the tyre casing of the arrangement, the quality of energy transfer between the two components and other parameters that influence this transfer, such as the distance D0 and the scanning angle α, it is better to take a range between 0.5 and 1.5 seconds. The upper limit of this range remains reasonable with respect to a conventional measurement, allowing the interrogation mode of the electronic device to qualified as instantaneous. Ideally, to ensure enough energy is transferred (especially when the electronic device must perform a number of tasks because of the multitude of sensors of the electronic device) a scan time of 1 second is recommended, in combination with other parameters of influence set according to the preferred mode, such as a distance D0 of zero, a location in line with a visual indicator and a scan of 5 degrees around the read position.

According to one specific embodiment, the factor μ by which the scanning angle of the radiofrequency transmission is decreased is a real number, preferably the number 2.

In the case where the lack of response from the electronic device is related to electromagnetic coupling of average quality between the external radiofrequency device of the electronic device of the arrangement, it is advisable to decrease the angular scan so as to transfer more energy to the electronic device, all the other conditions of interrogation of the electronic device, such as for example the transmission duration T0, being equal. Division by two is the preferred way for an operator to achieve a communication simply and rapidly.

According to another specific embodiment, the factor ρ by which the duration T0 of the radiofrequency transmission is multiplied is a real number, preferably the number 2.

In the case where the lack of response from the electronic device is related to a duration of exposure to the radiofrequency signals that is too short for the electronic device to store enough energy to perform its tasks, it is recommendable to increase the transmission duration. Thus, the energy transmitted to the electronic device is increased, all the other conditions of communication, such as for example the distance D0 or the scanning angle α, being equal. Multiplication by two is the preferred way for an operator to achieve a communication simply and rapidly.

According to one preferred embodiment, the external radiofrequency device is in linear polarization mode.

In this configuration, the external radiofrequency device transmits all the radiofrequency energy in one and the same direction. Thus, the amount of energy transmitted is optimal in this privileged direction and in other directions no radiofrequency energy is transmitted.

According to another preferred embodiment, the polar axis of the antenna of the external radiofrequency device is oriented according to information conveyed by the visual indicator.

Thus, if the transmission of radiofrequency energy is directional, it is possible to optimize this direction with respect to the orientation of the polar axis of the radiofrequency antenna of the electronic device. In particular, if the tyre casing is equipped with a visual indicator on the external surface of one of its sidewalls, this indicator may also provide the operator with information on the orientation of the polar axis of the radiofrequency antenna of the electronic device. In particular, whether this polar axis is oriented rather radially or circumferentially with respect to the movable reference mark of the tyre casing. Thus, by aligning the direction of transmission of the radiofrequency field of the external radiofrequency device with the polar axis of the electronic device, the transfer of energy to the electronic device is optimized, under given communication conditions. If the polar axis of the radiofrequency antenna of the electronic device is oriented axially, then the polar axis of the antenna of the external radiofrequency device should be positioned in the radial direction. In contrast, if the polar axis of the radiofrequency antenna of the electronic device is oriented circumferentially, the polar axis of the antenna of the external radiofrequency device should then be positioned in the circumferential direction. Otherwise, if the orientation of the radiofrequency antenna of the electronic device is a combination of the unit vectors of the axial and circumferential directions, it will be recommendable to orient the polar axis of the external radiofrequency device with the same combination of unit vectors of the radial and circumferential directions.

The invention will be better understood upon reading the following description, which is given solely by way of example, and with reference to the appended figures, throughout which the same reference numerals designate identical parts, and in which:

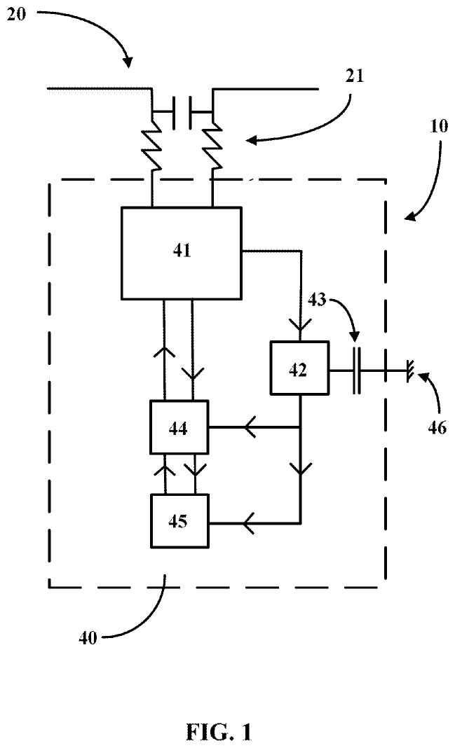

FIG. 1 shows an overview of the electronic device according to the invention;

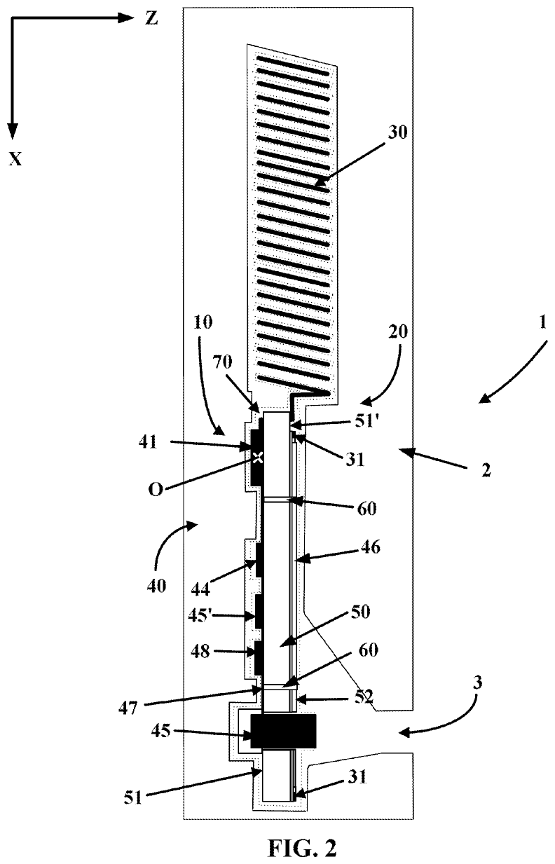

FIG. 2 is a cross-sectional view of the measuring system according to the invention;

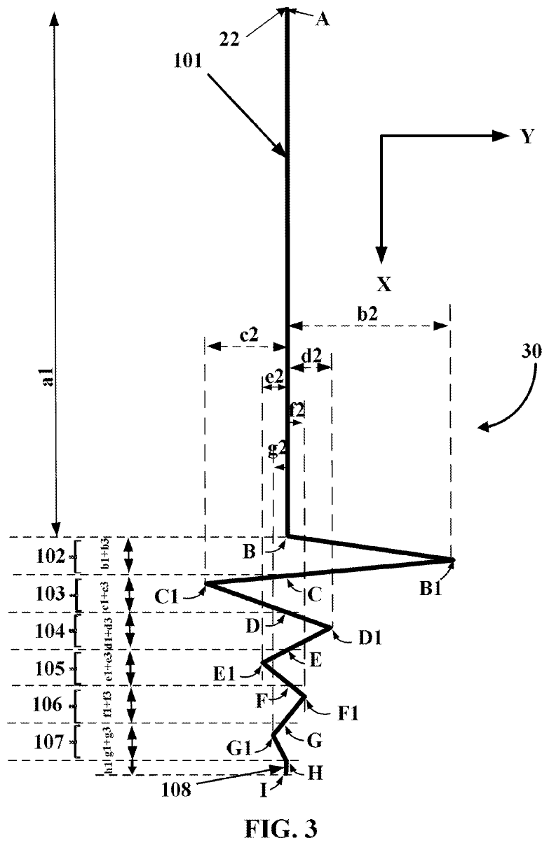

FIG. 3 is a view from above of a strand of the dipole radiating antenna;

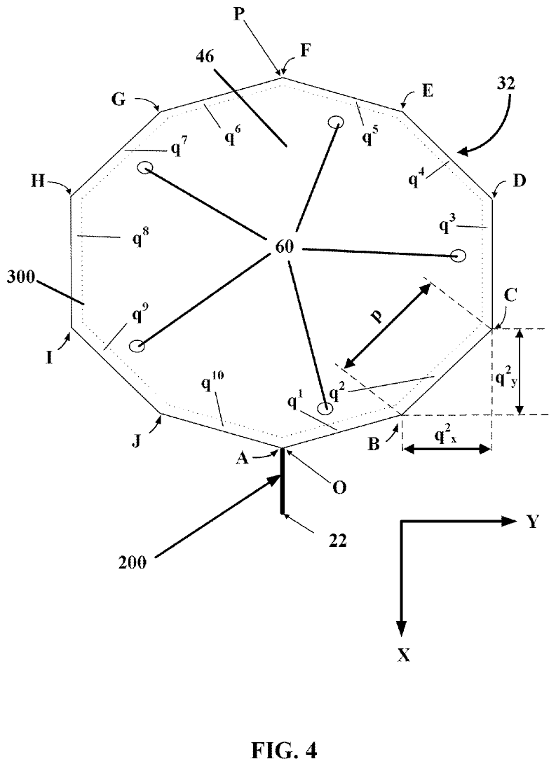

FIG. 4 is a view from above of a loop forming the strand of a dipole antenna according to the invention;

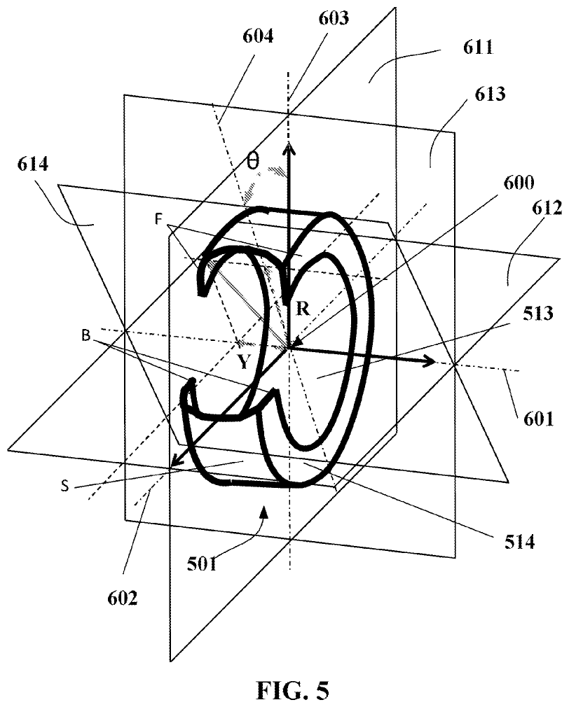

FIG. 5 is a cutaway in perspective of a tyre casing; and

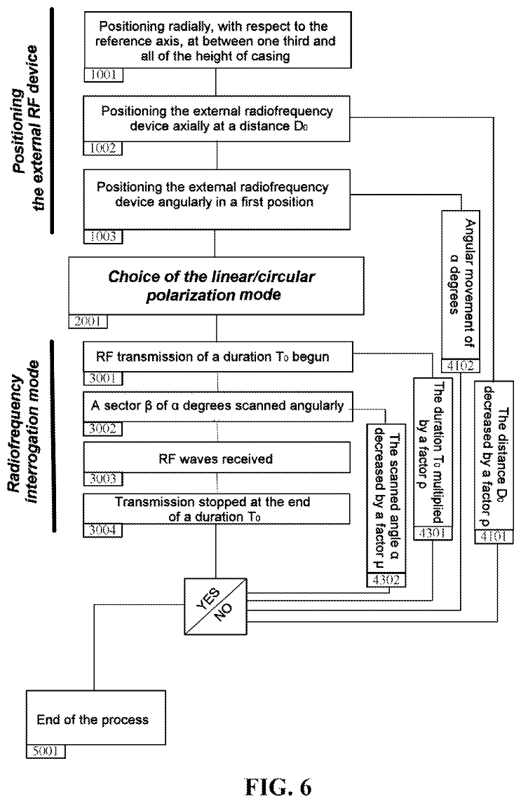

FIG. 6 is an overview of the method for achieving communication with a mounted assembly comprising an arrangement according to the invention.

Below, the terms “tyre” and “pneumatic tyre” are employed equivalently and refer to any type of pneumatic or non-pneumatic tyre.

The term “electronic device” comprises the UHF radiofrequency antenna, the circuit board and the ground plane.

The term “measuring system” comprises the electronic device and the bonding interface.

FIG. 1 shows an overview of the electronic device 10 of the system for measuring a parameter of the mounted assembly. On the one hand, the radiocommunication portion comprises a UHF radiating antenna 20 that is connected to the circuit board 40 via the electronic chip 41. If needs be, an impedance-matching circuit 21 is interposed between its two components in order to couple them efficiently and to optimize the transfer of electric power.

The circuit board 40 comprises a first sub-assembly ensuring power management. This sub-assembly comprises, on the one hand, a power manager 42 that serves as an interface between the electronic chip 41 and the capacitive element 43. Specifically, the electrical energy delivered to the electronic chip 41 is directed to the power manager 42, which directs the flow of energy to the capacitive element 43. This capacitive element 43 is the energy store of the circuit board 40. When the capacitive element 43 has reached a certain threshold allowing the circuit board 40 to begin to operate, the energy of the capacitive element 43 is released to the circuit board 40 via the power manager 42.

The circuit board 40 also comprises a second sub-assembly that carries out the measurement and post-processes this measurement, firstly comprising, from the electronic chip 41, a microcontroller 44. This microcontroller 44 ensures the communication of information between the electronic chip 41 and the sensor 45 for measuring a parameter of the mounted assembly. At the very least, communication from the microcontroller 44 to the electronic chip 41 is carried out. Often, the communication is two-way. Specifically, either the electronic chip 41 sends an instruction from a list of instructions to the microcontroller 44, or the electronic chip 41 transmits the information received from the microcontroller 44, the latter verifying that the transmitted information is compliant. The microcontroller 44 is also in communication with the measuring sensor 45. Communication is at least from the measuring sensor 45 to the microcontroller 44. Often it is two-way, in order to acknowledge the information transmitted or to transmit an operation to the measuring sensor from among a list of possible operations to be carried out, such as, for example, carrying out a measurement or communicating the partial or complete content of the memory of the measuring sensor 45 or any other task to be performed by the measuring sensor 45.

Apart from these first two sub-assemblies connected to each other by means of an electric circuit, the circuit board 40 is connected to a ground plane 46. Of course, the electric circuit galvanically connects all of the elements of the circuit board 40. It will be noted that when the measuring sensor 45 is of analogue type, a digital/analogue converter is incorporated between the microcontroller 44 and the measuring sensor 45 in order to decode or encode the information between the digital mode specific to the electronic chip 41 and the analogue mode of the measuring sensor 45. Lastly, the power manager 42 transmits the energy necessary for the correct operation of the circuit board 40 to at least the microcontroller 44, which then redistributes it to the measuring sensor 45. However, the power manager 42 may, as indicated in the overview, also directly supply the measuring sensor 45 and, if necessary, the digital/analogue converter.

FIG. 2 is a cross section through the system 1 for measuring a parameter of the mounted assembly, in the OXZ-plane. The X-direction is the direction of the polar axis of the UHF radiating antenna 20, which is here a half-wave dipole. The Z-direction is the direction vertical to the circuit board 40. Lastly, the point O is the centre of the electronic chip 41. The latter is conventionally in the shape of a parallelepiped, the vertical Z-direction of which corresponds to its smallest dimension.

This measuring system 1 comprises a bonding interface 2 including the radiating antenna 20, the ground plane 46 and the circuit board 40. This bonding interface 2 is a mass made of an elastomer blend. Thus any elastomer/elastomer adhesion solution may be used to fasten the measuring system 1 to the tyre casing. The bonding interface 2 comprises a through-orifice 3 that places the fluid located outside the bonding interface 2 in communication with the pressure- and temperature-measuring sensor 45, the measurement of which focuses on the properties of this fluid.

In this configuration, the measuring system 1 also comprises a first helical metal strand 30 connected to the circuit board 40. This helical strand 30 is mechanically anchored by means of an orifice that passes vertically through the printed circuit board 50, and of soldering of this metallic strand 30 to a metal pad, such as for example a pad made of copper, included in the electric circuit 47 of the circuit board 40. This point of attachment of the strand 30 corresponds to the feed point of this strand 30. The first element of the circuit board 40 connected via the electric circuit 47 to this pad is the electronic chip 41. The latter is also connected via the electronic circuit 47 to a second strand 31 of the radiating antenna. This connection corresponds to a second feed point for the UHF radiofrequency antenna 30.

This second strand 31 is here a metal circular loop, it is therefore an areal structure the plane of which contains the axis of rotation of the first helical strand 30 and the main direction of the loop of which is parallel to the axis of rotation of the first strand 30. Thus the two strands 30 and 31 indeed form a dipole radiating antenna. The length of the path travelled along each strand is tailored to a central communication frequency of approximately 433 MHz when the measuring system 1 is incorporated into a tyre casing, on the crown thereof. The second strand of the radiating antenna may be, in another variant of the measuring device 10, a single helical metal strand connected to the circuit board 40 so that the longitudinal axes of each strand are coaxial.

The circuit board 40 is constructed from a printed circuit board 50, one of the metal, here copper, faces 51 of which has been chemically etched in order to form the electric circuit 47, which consists of conductive wires that connect connection pads to which the various elements of the electronic device 10 are connected. These pads may be unapertured or apertured depending on the system used to anchor the elements to the printed circuit board 50. In the case of the helical strand 30 and of the loop 31, the pads are apertured. In the case of the power manager or of the capacitive element or of the microcontroller 44, they are unapertured, these elements being fastened to the printed circuit board 50 by bonding. The other face 51′ of the printed circuit board 50 is covered by a bilayer laminate, the upper layer 52 of which is metal in order to form the ground plane 46. Here, the ground plane 46 is dissociated from the loop 31 forming the second strand of the radiating antenna even though the two elements were initially both joined to the upper layer 52 of the laminate. Chemical etching of the metal layer 52 of the bilayer laminate allowed them to be physically and electrically dissociated via the insulating lower layer of the laminate.

The connection between the ground plane 46 and the circuit board is made via connecting elements 60 that connect the upper surface 52 of the printed circuit board to its lower surface 51. Connection on the side of the lower surface 51 is achieved via the electric circuit 47.

The first face 51 of the printed circuit board 50 accommodates the various elements of the circuit board 40. These are mechanically fastened to the printed circuit board 50 and electrically connected to the electric circuit 47. Here only the sub-assembly that takes the measurement is shown in FIG. 2. Firstly, the microcontroller 44 is directly connected to the electronic chip 41. Next, a measuring sensor 45 of the pressure-sensor type is connected to the microcontroller 44, and located between these two components is an analogue/digital converter 48. A second measuring sensor 45′ of the digital-accelerometer type is galvanically connected directly to the microcontroller 44.

It will be noted that the pressure sensor 45 passes through the printed circuit board 50. Specifically, it is electrically connected to the electric printed circuit 47 on the first face 51 of the printed circuit board 50. However, the active part of the pressure sensor 45 is located above the upper layer 52 of the bilayer laminate in the Z-direction. The pressure sensor 45 is fastened in place after the other electronic components have been connected.

A protective layer 70 is then necessary to protect these elements from physico-chemical attacks from the external environment of the measuring system 1. This protection 70 is achieved based on parylene deposited by condensation on top of the assembly consisting of the complete circuit board 40, of the ground plane 46 and of the radiofrequency antenna 20. This deposition process ensures a constant small thickness of protector over the entire external surface. Thus, maximum protection is achieved with a minimum mass of protector. Beforehand, the active region of the pressure sensor 45 has been protected so as not to be covered by this protection 70. The parylene mainly ensures hermeticity to solid and liquid pollution. Lastly, this protector 70 is compatible with the elastomer blends from which the bonding interface 2 is made. Of course another protector such as epoxy resin might have been used, but employment thereof would not have been as advantageous as employment of parylene.

FIG. 3 is an example of strand 30 of a UHF radiating antenna in a configuration that is optimal with respect to energy efficiency. This configuration is a two-dimensional structure that integrates perfectly into the system for measuring a parameter of the mounted assembly. The two ends A and I of the strand define the X-axis representing the axis of the UHF radiating antenna or polar axis. The Y-axis is the direction perpendicular to the X-axis in the plane of the strand 30. The point A here corresponds to the feed point 22 of the strand 30 of a UHF radiofrequency antenna of the electronic device.

It comprises a metal wire firstly comprising a rectilinear segment 101 between points A and B, of a length representing 50% of the total length of the strand. The point A is the end of the strand 30 that will be galvanically connected to the electronic chip. The second portion of the strand 30, between the points B and H, is a right meander-type structure that terminates in a rectilinear segment between points H and I representing 0.5% of the total length of the strand 30. In fact, the segment between points B and H is a succession of meanders 102, 103, 104, 105, 106 and 107, the dimension of which in the X-direction is constant and of a value equivalent to 1.5% of the length of the strand 30. However, their dimension in the Y-direction continuously decreases. For example, the meander 103 is bounded by points C and D. For each meander, the path travelled along the meander may be broken down into a component in the X-direction and a component in the Y-direction. The X-component of each meander is by the construction of this strand constant and has a value equivalent to 3% of the length of the strand 30. However, the Y-component of each meander, from the end B to the end H, continuously decreases by a factor of 2 from meander to meander, the maximum dimension on the meander 102 being equivalent to 8% of the length of the strand 30. This X-component of the meander 104 is the sum of the elementary distances d1 and d3. Regarding the Y-component of the same meander 104, it is twice the elementary distance d2. The formulas of the X- and Y-components are similar from one meander to the next.

Therefore, the path L0 travelled along this strand 30 is thus the full distance of the strand 30. The value of L0 is about 80 millimetres, which is indeed comprised in the interval desired for a half-wave dipole radiating antenna operating at a frequency of 900 MHz.

The oriented path L1 of this strand corresponds to the distance travelled in the X-direction alone, the X-direction being the direction of the axis of the radiating antenna. This path L1 is then simply defined by the following formula:

$$L 1 = {a}_{1} + {\sum }_{i = b}^{g} ( {i}_{1} + {i}_{3} ) + {h}_{1} = 0 , 685 * L 0$$

The value of L1 represents about 70 percent of the total path L0 travelled along the strand 30. Thus the role of most of the strand 30 is to permit the electric charge located on the strand 30 to be accelerated by the electric field of the radiofrequency device.

Lastly, the optimal oriented path L2 of this strand 30, which corresponds to the largest continuous portion of the strand 30 perfectly aligned with the X-direction, which corresponds to the axis of the radiating antenna, is then defined by the following formula:

L2=a₁=0.5*L0

The optimal oriented path L2 is indeed more than 70 percent of the oriented path L1 of the strand 30 of the radiating antenna. In addition, this optimal oriented path L2 comprises the end A of the strand, which will be placed in line with the electrical connection to the electronic chip.

FIG. 4 is a view from above of a strand 32 of the UHF radiating antenna integrated into the ground plane 46 of the electronic device. The ground plane 46 is here bounded by a regular hexagon defining a total area of about 500 square millimetres. The ground plane 46 has on its face five connection elements 60 between the ground plane 46 and the circuit board, and allowing an electrical connection to be made. At one end of the hexagon is a small rectilinear segment 200, which will be neglected for the evaluation of the paths of the strand. Alignment of this rectilinear section 200 with the axis of the UHF radiofrequency antenna is desirable as it allows a half-wave dipole antenna to be produced in which a first strand is the loop 32 integrated into the ground plane 46. This alignment represents the X-axis or polar axis. The end left free of this rectilinear section 200 represents a feed point 22 of the UHF radiofrequency antenna. The Y-direction is orthonormal to the X- and Z-directions, where the Z-direction is the direction normal to the ground plane 46 directed externally to the circuit board.

Each vertex of the hexagon is defined by a letter from A to J in the clockwise direction around the hexagon in the XY-plane. Each segment qⁱ of the hexagon has a length p which, depending on the orientation of the section of length p in the XY-plane, defines a component qⁱₓ in the X-direction and a component qⁱ_{y} in the Y-direction.

The loop strand 32 may then be considered to be located on the periphery of the ground plane 46. In fact, this region corresponds to the area of movement of the electric charge located on the ground plane 46 when the latter is placed in an electric field E parallel to the ground plane 46. The line of dots 300 represents what may be considered to be the thickness of this loop 32, so as to allow this thickness to be seen in FIG. 4.

The intersection of the loop 32 and the X-axis defines a first point O and a second point P, in order starting from the rectilinear section 200. The distance defined by the regular hexagon between these two points is constant, independently of the direction in which it is chosen to measure it around the regular hexagon. This distance travelled corresponds not only to the half-perimeter D of the loop 32 but also to the travelled path L0 of the loop 32. This distance is defined, considering solely segments q¹ to q⁵ of the regular hexagon, by the following formula:

$$L 0 = {\sum }_{i = 1}^{5} {q}^{i} = 5 p$$

It is then easy to determine the oriented path L1 of the loop 32, simply by considering the projections of the sections of the regular hexagon onto the X-direction. Thus the oriented path L1 is obtained using the following formula:

$$L 1 = {\sum }_{i = 1}^{5} {q}_{x}^{i} = 3 , 72 * p = 0 , 74 * L 0$$

This loop-type strand 32 allows an oriented path suitable for achieving a sufficient energy efficiency to be obtained. However, this energy efficiency is not optimal due to the orientation of the loop strand 32. However, the particular shape of this antenna ensures the compactness of the measuring system, as it allows the ground plane 46 to play a first role as an electrical regulator of the circuit board and a second role as a radiofrequency strand.

FIG. 5 shows a cross section of a pneumatic tyre 501 according to the invention comprising a crown S extended by two sidewalls F and terminating in two beads B. In this case, the tyre 501 is intended to be mounted on a wheel (not shown in this figure) via the two beads B. A closed cavity containing at least one pressurized fluid is thus defined, this cavity being bounded both by the second surface 513 radially internal to the tyre 501 and by the external surface of the wheel. The tyre casing 501 also comprises a first surface 514 that is radially external to the tyre casing 501.

The reference axis 601, which corresponds to the reference axis or natural axis of rotation of the tyre 501, and the median plane 611, which is perpendicular to the reference axis 601 and equidistant from the two beads, will be noted. The intersection of the reference axis 601 with the median plane 611 defines the centre of the pneumatic tyre 600. A Cartesian coordinate system is defined at the centre of the pneumatic tyre 600, this system consisting of the reference axis 601, of a vertical axis 603 perpendicular to the ground and of a longitudinal axis 602 perpendicular to the other two axes. Furthermore, an axial plane 612 is defined that passes through the reference axis 601 and the longitudinal axis 602, parallel to the plane of the ground and perpendicular to the median plane 611. Lastly, the vertical plane 613 is the plane that is perpendicular both to the median plane 611 and to the axial plane 612 and that passes through the vertical axis 603.

Any material point of the tyre 501 is uniquely defined by its cylindrical coordinates (Y, R, θ). The scalar Y represents the axial distance to the centre of the pneumatic tyre 600 in the direction of the reference axis 601, i.e. the distance defined by the orthogonal projection of the material point of the tyre 501 onto the reference axis 601. A radial plane 614 making an angle θ to the vertical plane 613 around the reference axis 601 is defined. The material point of the tyre 501 is identified, in this radial plane 614, by the distance R to the centre of the pneumatic tyre 600 in the direction perpendicular to the reference axis 601, i.e. the distance identified by the orthogonal projection of this material point on the radial axis 604. The unit vector perpendicular to the radial plane 614, which vector forms, with the unit vectors of the axial direction 601 and radial direction 604, a direct system of axes, represents the circumferential direction of the tyre casing 501.

FIG. 6 is an overview of the method for achieving communication between a mounted assembly comprising an arrangement according to the first object of the invention and an external radiofrequency device. This method comprises three essential phases.

The first phase, incremented from 1000, consists in positioning the external radiofrequency device with respect to the tyre casing equipped with an electronic device for measuring parameters of the mounted assembly. This reader positioning comprises a first step 1001 consisting in positioning the external radiofrequency device radially with respect to the reference axis of the tyre casing. The external radiofrequency device is positioned between one third and all of the height of the sidewall of the tyre casing.

The second step 1002 consists in bringing axially the polar axis of the radiofrequency antenna of said external device to a distance D0 from the, radially external, second surface of the tyre casing. This distance D0 is preferably zero, leading to the best possible radiofrequency coupling. However, to avoid any contact between the two components, i.e. the tyre casing and the external radiofrequency device, it is possible to place the polar axis up to 1 metre away.

In the third positioning step 1003 of the communication method, the external radiofrequency device is placed angularly with respect to the tyre casing. If there is no visual indicator on the external sidewall of the mounted assembly indicating the presence of the measuring electronic device, the azimuth is chosen at random. Otherwise, the external radiofrequency device is positioned in such a way that the azimuth of the polar axis of the device is in line with the visual indicator of the tyre. Moreover, if the visual indicator provides the operator with information on an orientation of the polar axis of the measuring electronic device, the polar axis of the external device should then be oriented as indicated.

In the second phase of the communication method, which phase is incremented from 2000, the polarization mode of the radiofrequency antenna of the external device is chosen. Specifically, it is possible to choose a circular polarization mode or a linear polarization mode. The first mode leads to the transmission of radiofrequency energy in an omnidirectional manner, and the second mode leads to the transmission of energy in one single direction. For a given amount of energy transmitted by the external device, the second mode will transmit a higher power to the measuring electronic device. However, if the direction of the linear mode is orthogonal to the polar axis of the measuring electronic device, no energy will be transmitted to the electronic device. The polarization mode is chosen in step 2001.

If information on the orientation of the polar axis of the measuring electronic device is provided by the visual indicator on the sidewall of the tyre casing or on the data sheet of this same casing, the operator will choose the linear polarization mode in order to optimize the coupling of energy between the two components. Otherwise, and in any case prudently, he will choose the circular polarization mode to be certain to transmit energy to the measuring electronic device.

In the third phase of the communication method, which phase is incremented from 3000, the mode of radiofrequency interrogation between the external device and the measuring electronic device present in the tyre casing is chosen.

After the polarization mode of the antenna of the external radiofrequency device has been defined and the external radiofrequency device has been positioned with respect to the tyre casing, the first step 3001 consists in transmitting the UHF radiofrequency transmission to the electronic measuring device for a continuous duration T0. Thus, the external device transmits radiofrequency waves for a duration T0 in a chosen direction. This duration T0 is at least 500 milliseconds, in order to transfer sufficient energy to the electronic device for it to be able to perform its basic tasks. The duration T0 may be as long as two seconds in the event of poor coupling between the external device and the electronic device and of execution of a more complete set of tasks by the measuring device. However, for a standard pressure measurement, an interrogation duration of one second or two seconds is a good compromise.

After this first step, in step 3002, the operator angularly scans a sector β of α degrees from the first read position of the external radiofrequency device. The way in which this angular scan is performed is unimportant: it may be a reciprocating or progressive scan. The objective is to transmit a certain amount of radiofrequency energy to a given volume of the tyre casing.

Therefore, a scan over a sector of 30 degrees is reasonable, in particular in the case where no information is provided on the azimuthal position of the measuring electronic device. However, the coupling will be more efficient with an angle of 20 degrees, above all if the request made by the operator via the external device is a request, such as a request for the inflation pressure of the mounted assembly corrected for thermal variations, that will cause the measuring electronic device to consume much power. Lastly, a 5-degree scan is entirely realistic in the case of presence of a visual indicator, even in circular polarization mode.

The third step 3003 of this phase consists in collecting the radiofrequency waves returned by the measuring electronic device in response to the interrogation, before this phase ends in a final step 3004 of stopping the radiofrequency transmission. Specifically, the measuring electronic device is a passive system that uses the radiofrequency transmission of the external device to transmit the requested responses. Thus, part of the radiofrequency-transmission duration T0 is devoted to receiving the returned radiofrequency waves.

Depending on whether a response is received from the measuring electronic device by the external device, the communication method will either be stopped, in step 5001, since the requested information has been transmitted, or adjustments made to the communication method via a correction phase that is incremented from 4000.

There are two separate categories of correcting steps. The first category aims to optimize the positioning of the external radiofrequency device with respect to the measuring electronic device: the associated steps are incremented from 4100. The second category is more to do with the radiofrequency interrogation mode: the corresponding steps are incremented from 4300.

In the context of optimization of the position of the external device with respect to the measuring electronic device, the possible first step 4101 consists in decreasing the axial distance D0 between the external device and the tyre casing accommodating the electronic device. This step is in particular to be envisaged in the case of a request that is said to consume much power in the measuring electronic device, for example a request for the inflation pressure of the mounted assembly corrected for thermal variations.

The second step 4102 conceivable in this category consists in modifying the scanned angular sector. This correction is highly recommended in the absence of a visual indicator on the sidewall of the tyre providing the operator with information on the azimuthal position of the measuring electronic device within the tyre casing.

Among the steps of the second category of corrections, step 4301 consists in extending the duration T0 of radiofrequency transmission from the external device. This correction is desirable if the polarization mode of the radiofrequency antenna is of the circular polarization type, the transmission of radiofrequency energy to the measuring electronic device not being optimal in this mode. Likewise, if the requested request consumes much power, it is preferable to also increase the duration of the radiofrequency transmission.

Lastly, if there is no visual indicator on the external surface of the sidewall of the tyre casing and a first angular sector β has been scanned without obtaining a response in return, the operator may choose to implement step 4302, which consists in decreasing the angular amplitude of the scan in order to transmit, for a given duration T0 of the radiofrequency transmission, a greater amount of energy to the measuring electronic device.

When one or more correcting steps are carried out, it is recommendable to carry out the interrogating phase again in order to obtain a second communication-method result. In case of a response, the communication method ends in step 5001. Otherwise, new corrections that are reasonable with respect to the range of the various parameters of the communication method will need to be chosen and the interrogation mode restarted.

1.-22. (canceled)

23. An arrangement comprising:
a tire casing;
an electronic device for measuring parameters of a mounted assembly; and
a bonding interface made of elastomeric material at least partially covering the electronic device and serving as an interface between the tire casing and the electronic device;
the electronic device comprising:
a UHF radiofrequency antenna defining a polar axis; and
a circuit board comprising:
an electronic chip electrically coupled to the UHF radiofrequency antenna by at least one galvanic transmission line; and
at least one sensor for measuring a parameter of the mounted assembly;
the tire casing comprising:
a crown, two sidewalls and two beads of revolution about a reference axis defining a first surface located externally and a second surface located internally to the tire casing with respect to the reference axis; and
a median plane perpendicular to the reference axis and equidistant from the two beads,
wherein the bonding interface is fastened in line with the crown to the second surface of the tire casing, and
wherein at least one feed point defined as an intersection between the polar axis and the at least one galvanic transmission line is located axially in a central region of the crown of the tire casing.

24. The arrangement according to claim 23, wherein the circuit board comprises a microcontroller, a capacitive element and a power manager, and the electronic components of the circuit board are low-consumption components.

25. The arrangement according to claim 23, wherein the electronic device comprises a ground plane connected to the circuit board.

26. The arrangement according to claim 23, wherein the at least one feed point is located in the median plane of the tire casing.

27. The arrangement according to claim 23, wherein the tire casing comprises at least one visual indicator located on the first surface of the tire casing in line with one of the sidewalls, and the bonding interface is located at an azimuth separated from an azimuth of the at least one visual indicator by less than 15 degrees.

28. The arrangement according to claim 27, wherein the azimuth of the bonding interface is superposed on the azimuth of the at least one visual indicator.

29. The arrangement according to claim 23, wherein the UHF radiofrequency antenna is a single-band half-wave dipole antenna, the total length L of which is comprised between the following limits:
0.9*C/(2*f)<L<1.1*C/(2*f),
in which, C is a speed of radiofrequency waves in a medium in which the UHF radiofrequency antenna is embedded and f is a communication frequency of the UHF radiofrequency antenna.

30. The arrangement according to claim 23, wherein the polar axis of the UHF radiofrequency antenna is parallel to a circumferential direction of the tire casing.

31. The arrangement according to claim 23, wherein the polar axis of the UHF radiofrequency antenna is parallel to the reference axis of the tire casing.

32. A method for achieving communication between a mounted assembly and an external radiofrequency device comprising a radiofrequency antenna having a polar axis, the mounted assembly comprising an arrangement according to claim 23, comprising the following steps:
positioning the external radiofrequency device radially at a radial distance R, with respect to the reference axis, comprised between one third and all of the height of the tire casing;
bringing axially, in line with one of the sidewalls of the tire casing, the polar axis of the radiofrequency antenna of the external radiofrequency device to a distance D0, with respect to the first surface of the tire casing of the mounted assembly, defining a first read position; and
transmitting a radiofrequency transmission with the external radiofrequency device for a duration T0 while angularly scanning a first angular sector β of α degrees.

33. The method according to claim 32, wherein, if no response has been obtained by the external radiofrequency device, the external radiofrequency device is moved to a second position located at α degrees from the first position before restarting the radiofrequency transmission.

34. The method according to claim 32, wherein, if no response has been obtained by the external radiofrequency device, the distance D0 between the polar axis of the antenna of the external radiofrequency device and the first surface of the tire casing is decreased by a factor γ before the radiofrequency transmission is restarted.

35. The method according to claim 32, wherein, if no response has been obtained by the external radiofrequency device, the angle α of the scanned first angular sector β is decreased by a factor μ before the radiofrequency transmission is restarted.

36. The method according to claim 32, wherein, if no response has been obtained by the external radiofrequency device, the duration T0 of the interrogation mode is multiplied by a factor ρ before the radiofrequency transmission is restarted.

37. The method according to claim 32, wherein the distance D0 is between 0 and 1 m.

38. The method according to claim 32, wherein the tire casing comprises at least one visual indicator located on the first surface of the tire casing in line with one of the sidewalls, and the bonding interface is located at an azimuth separated from an azimuth of the at least one visual indicator by less than 15 degrees, and wherein the external radiofrequency device is positioned in line with the at least one visual indicator.

39. The method according to claim 32, wherein the scanned angular sector β of the radiofrequency transmission is 30 degrees.

40. The method according to claim 32, wherein the duration T0 of the radiofrequency transmission is between 0.5 and 2.0 seconds.

41. The method according to claim 35, wherein the factor μ by which the scanning angle of the radiofrequency transmission is decreased is a real number.

42. The method according to claim 36, wherein the factor ρ by which the duration T0 of the radiofrequency transmission is multiplied is a real number.

43. The method according to claim 32, wherein the external radiofrequency device is in linear polarization mode.

44. The method according to claim 43, wherein the tire casing comprises at least one visual indicator located on the first surface of the tire casing in line with one of the sidewalls, and the bonding interface is located at an azimuth separated from an azimuth of the at least one visual indicator by less than 15 degrees, and wherein the polar axis of the antenna of the external radiofrequency device is oriented depending on information of the at least one visual indicator.
